(19) United States
(12) Patent Application Publication
(10) Pub. No.: US 2013/0223361 A1
(43) Pub. Date: Aug. 29, 2013

(54) TERMINAL AND METHOD FOR ESTABLISHING WIRELESS ACCESS CHANNEL

(71) Applicant: PANTECH CO., LTD., (US)

(72) Inventors: Hyung-Ik PARK, Seoul (KR); Yong-Jun CHO, Seoul (KR)

(73) Assignee: PANTECH CO., LTD., Seoul (KR)

(21) Appl. No.: 13/658,245

(22) Filed: Oct. 23, 2012

(30) Foreign Application Priority Data
Feb. 24, 2012 (KR) 10-2012-0019340

(51) Int. Cl. H04W 72/04

(52) U.S. Cl. 370/329

(57) ABSTRACT

A terminal to establish a wireless access channel, includes an input unit to receive a user input to establish a wireless access channel for a data transfer, the user input corresponding to first identification information, a flow control unit to search for a target terminal in response to the user input and to establish a wireless access channel with the target terminal if a response including second identification information corresponding to the first identification information is received from the target terminal, and a control unit to check whether the second identification information corresponds to the first identification information.

### CROSS-REFERENCE TO RELATED APPLICATION

This application claims priority from and the benefit under 35 U.S.C. §119(a) of Korean Patent Application No. 10-2012-0019340, filed on Feb. 24, 2012, which is hereby incorporated by reference for all purposes as if fully set forth herein.

### BACKGROUND

1. Field

The following description relates to a technique for establishing a wireless channel of a wireless communication apparatus available for a wireless access.

2. Discussion of the Background

Generally, a wireless direct access communication refers to data exchange between wireless communication devices over an established wireless channel through one-to-one (1:1) or one-to-many (1:N) communication, such as Bluetooth® and WiFi.

Typically, file transmission and reception processes using a wireless direct access communication are as follows: First, a terminal for transmitting data (hereinafter, referred to as a “transmission terminal) detects terminals available for a wireless direct access, and a number of available reception terminals are displayed on a display of the transmission terminal. If a user of the transmission terminal selects one of the displayed terminals available for the wireless direct access and transmits a request for the wireless direct access with identification information, a user of the selected terminal may input the identification information in response to the request for the wireless direct access transmitted from the transmission terminal. Once the terminals for the wireless direct access are determined, messages are, then, transmitted and received between the determined terminals to establish the wireless direct access, and data exchange is performed through the established channel.

The above conventional method may cause difficulties in use due to the following drawbacks.

In a 3rd generation (3G) or 4th generation (4G) network or a WiFi-network, mobile communication terminals automatically access the network, and thus users do not feel any inconvenience, whereas the wireless direct access communication may be difficult to use for mobile communication terminal users without understanding how to operate the wireless direct access. Further, due to complicated settings of conventional wireless direct access procedures, users need to provide the terminal with a number of inputs to establish a wireless direct access communication, which may cause inconvenience for users who are not acquainted with the complicated procedure. Furthermore, it may be difficult for a general user to find a target terminal that the user wants to communicate with because it is not easy for the user to identify the name or user of the target terminal when selecting the target terminal.

### SUMMARY

Exemplary embodiments of the present invention provide an apparatus and method for establishing a wireless direct access channel for data transfer with less user manipulations.

Additional features of the invention will be set forth in the description which follows, and in part will be apparent from the description, or may be learned by practice of the invention.

An exemplary embodiment of the present invention provides a terminal to establish a wireless access channel, including an input unit to receive a user input to establish a wireless access channel for a data transfer, the user input corresponding to first identification information; a flow control unit to search for a target terminal in response to the user input, and to establish a wireless access channel with the target terminal if a response including second identification information corresponding to the first identification information is received from the target terminal; and a control unit to check whether the second identification information corresponds to the first identification information.

An exemplary embodiment of the present invention provides a terminal to establish a wireless access channel, including an input unit to receive a user input corresponding to first identification information; a signal processing unit to receive a probe request for establishing a wireless access channel from a transmission terminal, and to transmit a probe response in response to the probe request; a control unit to generate the probe response including the first identification information; and a flow control unit to establish a wireless access channel with the transmission terminal if a connection request message is received in response to the probe response, and to receive data via the established wireless access channel.

An exemplary embodiment of the present invention provides a method for establishing a wireless access channel, including receiving a user input to establish a wireless access channel for a data transfer, the user input corresponding to first identification information; searching for a target terminal in response to the user input; receiving a probe response including second identification information from the target terminal; determining whether the second identification information corresponds to the first identification information; and establishing a wireless access channel with the target terminal if the second identification information corresponds to the first identification information.

An exemplary embodiment of the present invention provides a method for establishing a wireless access channel, including receiving a user input corresponding to first identification information; receiving a probe request for establishing a wireless access channel from a transmission terminal; transmitting a probe response including the first identification information in response to the probe request; establishing a wireless access channel with the transmission terminal if a connection request message is received in response to the probe response; and receiving data via the established wireless access channel.

It is to be understood that both forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a flowchart illustrating a method for forming a wireless access channel according to an exemplary embodiment of the present invention.

FIG. 2 is a diagram illustrating a wireless communication apparatus according to an exemplary embodiment of the present invention.

FIG. 3 is a diagram illustrating a wireless communication apparatus according to an exemplary embodiment of the present invention.

FIG. 4 is a flowchart illustrating a method for establishing a wireless access channel by a transmission terminal according to an exemplary embodiment of the present invention.

FIG. 5 is a flowchart illustrating a method for establishing a wireless access channel by a reception terminal according to an exemplary embodiment of the present invention.

### DETAILED DESCRIPTION OF THE ILLUSTRATED EMBODIMENTS

The invention is described more fully hereinafter with references to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity, illustration, and convenience.

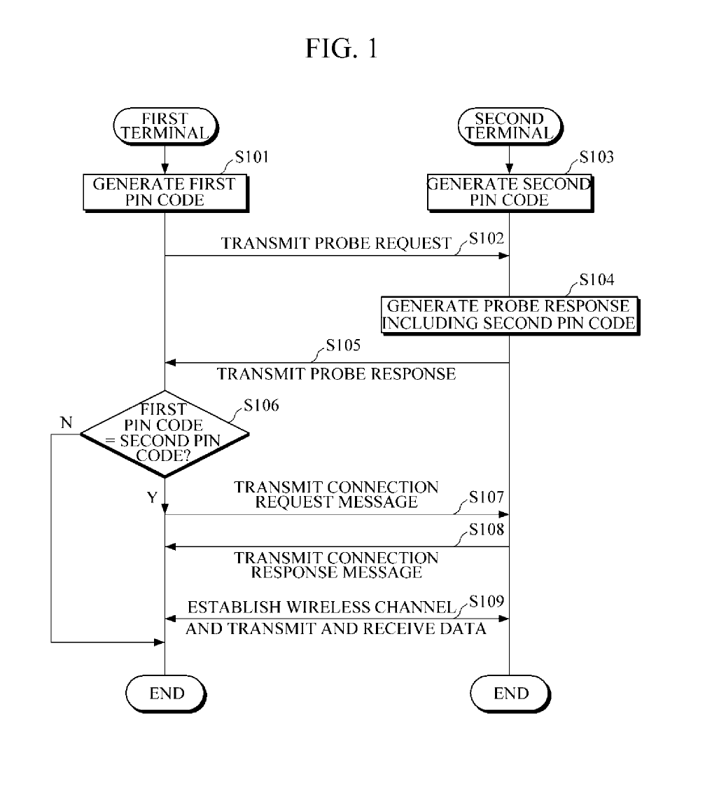

FIG. 1 is a flowchart illustrating a method for forming a wireless access channel according to an exemplary embodiment of the present invention.

In FIG. 1, a first terminal and a second terminal may be mobile phones, smart phones, tablet PCs, or the like, which can be wirelessly connected to each other.

Referring to FIG. 1, the first terminal may generate first identification information that corresponds to a first input of a first user in operation S101. For example, the first terminal may recognize the first input, such as a user's motion, touch, gesture, voice, key input, or the like, and generate a first personal identification number (PIN) code as the first identification information corresponding to the recognized first input according to a code table. The code table may include mapping information between specific inputs, e.g., motions, and identification information, such as the PIN code. For example, user's motion inputs and arbitrary numbers are mapped to each other. The PIN code may be a multi-digit number.

The first terminal may transmit a probe request to the second terminal in operation S102. The probe request may be a request signal or a search message to find a terminal available for wireless connection. For example, the probe request may be similar to a probe request frame among frame types defined in IEEE 802.11 specification.

The second terminal may generate second identification information that corresponds to a second motion of a second user in operation S103. For example, the second terminal may recognize a second user's motion, and generate a second PIN code corresponding to the recognized motion according to a code table. The code table of the second terminal may be the same code table as used by the first terminal.

In response to a receipt of the probe request, the second terminal may generate a probe response including the second PIN code in operation S104. The probe response may be a response signal with respect to the probe request. The probe response may be similar to a probe response frame defined in IEEE 802.11 specification. The probe response may further include the second identification information.

The second terminal may transmit the probe response containing the second identification information to the first terminal in operation S105.

In operation S106, the first terminal may determine whether the second identification information included in the probe response is identical to or matches the first identification information that has been generated in operation S101. For example, if the first user and the second user generate the same motion mapped to the same PIN code to their terminals, respectively, the first PIN code generated by the first terminal may be identical with the second PIN code generated by the second terminal when the first terminal and the second terminal store the same code table. Aspects need not be limited thereto such that the first and second identification information need not be identical and may be deemed to match if the first and second identification information are similar to within a tolerance. The user's motion may vary. Examples of the user's motion may include shaking a terminal in a particular direction, specific gestures that can be detected by various types of sensors embedded in the terminal, and a touch on a keypad or a touch sensor.

If the first identification information is identical to or matches the second identification information, the first terminal may transmit a connection request message to the second terminal to establish a wireless access channel with the second terminal in operation S107.

In response to the connection request message, the second terminal may transmit a connection response message to the first terminal in operation S108.

A wireless access channel is established between the first terminal and the second terminal, and data is exchanged between the first and second terminals over the wireless access channel in operation S109. The established wireless access channel may be a wireless direct connection channel. If the first identification information is not identical to or does not match the second identification information, the first terminal may terminate the wireless direct access procedure or retransmit the probe request.

In another aspect, the first terminal and the second terminal may be able to activate a module involved in direct wireless communications without a subsequent user input.

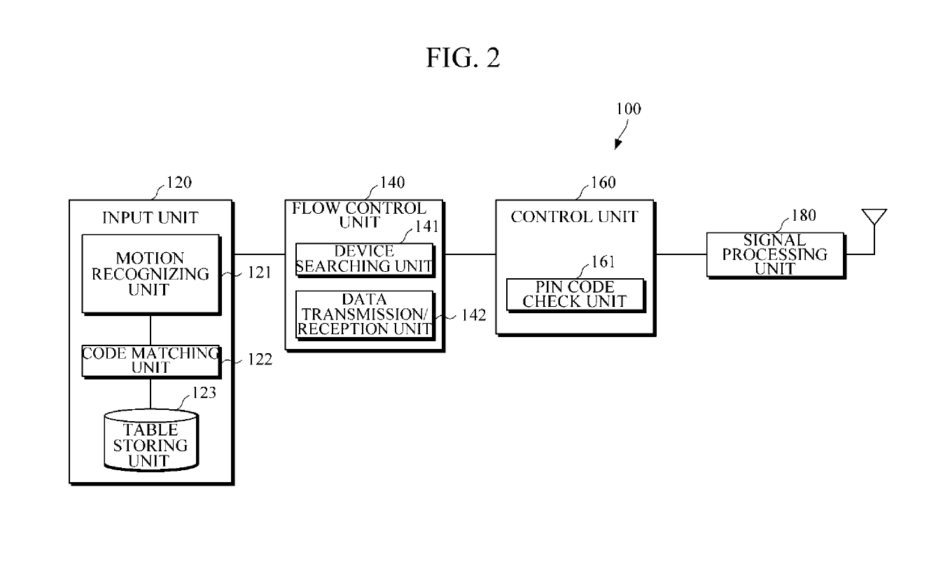

FIG. 2 is a diagram illustrating a wireless communication apparatus according to an exemplary embodiment of the present invention. The wireless communication apparatus shown in FIG. 2 may be an example of a transmission terminal (for example, the first terminal in FIG. 1).

Referring to FIG. 2, the wireless communication apparatus 100 includes an input unit 120, a flow control unit 140, a control unit 160, and a signal processing unit 180.

The input unit 120 receives an input from a user who attempts to transmit data, e.g., a file, and in response to the user's input, generates a PIN code (for example, a first PIN code) used for direct wireless connection. The input unit 120 may transmit path information of the data to be transmitted by the user and the PIN code generated in response to the user's input, along with a data transfer request to the flow control unit 140. The flow control unit 140 may initiate a data transmission process in response to the data transfer request. Information to be decided and transmitted from a user to the input unit 120 may include the path information of the data to be transmitted and a user's motion for generating PIN code. The user input may include at least one of a motion sensed by a camera of the wireless communication apparatus 100, a key pad input, an input sensed by an embedded sensor of the wireless communication apparatus 100, and a touch input. The touch input may include a pattern lock input corresponding to a PIN code.

In one aspect, the input unit 120 may include a motion recognizing unit 121, a code matching unit 122, and a table storing unit 123.

The motion recognizing unit 121 recognizes an input, such as a user's motion. The motion may include various operating motions such as a touch motion. For example, the motion recognizing unit 121 may analyze sensing information from a touch screen, a camera, a pressure sensor, a gyroscope sensor, an acceleration sensor, and the like, and to recognize the user's motion or input.

The code matching unit 122 converts the recognized motion to a sensed value, and searches for the code table for identification information, e.g., a PIN code, that matches the converted value. In response to a user's motion input to the terminal, a data transfer request may be sent to an application that manages a user interface configured to receive the data transfer request from the user. In the case of a terminal equipped with an Android platform, the user input received through one or more sensors or a touch screen may be recognized as user input information to an application running on an operating system and the Android platform. The user input (the user's motion) which is recognized on the touch screen or by a sensor may be transmitted to the application through Android Intent. Android Intent may be data transfer component in a system environment using the Android platform. The motion recognizing unit 121 may transmit the user input information received through the Intent to the code matching unit 122. The user input may include sensing information of various sensing devices (e.g. a camera, a gyro sensor, etc.) and sensors, such as a touch screen and a keypad that are generally used in a smartphone to recognize a user's motion. In response to a selection of data to be sent in the terminal, the user input information may be transmitted to the code matching unit 122. The user's motion that is input when the data is selected or various types of input may be provided to use.

The code matching unit 122 converts the user input information transmitted from the motion recognizing unit 121 into a value of a defined format, searches for a matching PIN code in the code table stored in the table storing unit 123, and stores the found PIN code in a separate storage area.

An example of the code table stored in the table storing unit 123 is provided in table 1. The exemplary code table shown in table 1 illustrates a two-column table in which integer values and PIN codes are matched to each other.

| User Input Information | Integer Value | PIN code |
|---|---|---|
| Touch Drag from Right to Left | 1 | 00000001 |
| Touch Drag from Left to Right | 2 | 00000002 |
| Touch Drag toward Bottom | 3 | 00000003 |
| Touch Drag toward Top | 4 | 00000004 |
| . . . | . . . | . . . |
| Shake Terminal in Downward Motion | 123 | 00000123 |
| . . . | . . . | . . . |
| . . . | . . . | . . . |

The code table may be managed in the form of a file, and may be loaded onto a memory at the time of running the application for a data transfer, or at the time of searching for PIN code. PIN code search in the code table may be implemented as a function that has an integer value corresponding to the user input information as an element and returns a PIN code value as char-type string. Each row of the code table may be managed in the form of a struct and be stored in the form of a linked list structure or an array. In the case of storing each row in an array, sequentially managing integer values corresponding to user input information may enhance a search speed. The found PIN code may be stored and managed in a specific memory area.

If the PIN code is found, the input unit 120 may transmit the data transfer request to the flow control unit 140 together with the data path information designated by the user and information about the found PIN code. The flow control unit 140 may complete establishing the connection with a target terminal for a wireless direct access in response to the data transfer request from the input unit 120, and perform data transmission/reception with the target terminal.

The flow control unit 140 searches for a target terminal in response to the data transfer request received from the input unit 120, and processes the overall procedure for transferring data to the target terminal without an additional user's input. The flow control unit 140 may be implemented in the form of service of Android platform that is used in the terminal, or be implemented as a part of an application.

In one aspect, the flow control unit 140 may include a device searching unit 141 and a data transmission/reception unit 142.

The device searching unit 141 searches for the target terminal to transfer the data, and establishes a direct wireless connection with the target terminal.

After receiving a notification from the device searching unit 141 that the direct wireless connection is completed, the data transmission/reception unit 142 manages data transmission and reception with the target terminal. The target terminal can be identified based on user input motions that are the same or agreed upon by both users of the transmission terminal and the reception terminal, the target terminal.

If WiFi-Direct is used as a wireless direct connection method, the flow control unit 140 may perform the operations described below.

The input unit 120 transmits the data transfer request along with the PIN code to the flow control unit 140. The flow control unit 140 controls the device searching unit 141 to request the control unit 160 to activate a WiFi-Direct device. In response to a notification receipt for the activation of the WiFi-Direct device from the control unit 160, the device searching unit 141 requests the control unit 160 to search for a device available for WiFi Direct connection to find a target device. The control unit 160 sends a probe request for a terminal search, and continues to search for a terminal available for WiFi-Direct while monitoring a probe response. If the control unit 160 completes searching for the target terminal to transfer the data and notifies the completion of the target terminal search to the device searching unit 141, the device searching unit 141 directs the control unit 160 to send a connection request message to the found target terminal to initiate a wireless direct access connection. If the device searching unit 141 receives a notification of the completion of the wireless direct access connection with the target terminal from the control unit 160, the data transmission/reception unit 142 performs data transmission/reception with the target terminal with which the connection has been completed.

The procedures of data transmission/reception will be described in detail. During the WiFi-Direct connection, an IP address is allocated for the WiFi-Direct connection between the terminals and shared between the connected terminals. The IP allocation may be performed using the Dynamic Host Configuration Protocol (DHCP) protocol. In the DHCP, one of the connected terminals serves to allocate the IP address and the other terminal requests the allocation of the IP address and is allocated with the IP address. The terminal allocating the IP address autonomously generates the IP address, and allocates the IP address to the other terminal on request through DHCP. The IP address to be used for the WiFi-Direct connection for a data transmission/reception may be given by the control unit 160 at the time of notifying the flow control unit 140 of the completion of the WiFi-Direct connection. IP address allocation enables a number of terminals to be connected to each other, and the terminals are allocated with the corresponding IP addresses. For example, one terminal can function as a File Transfer Protocol (FTP) server, and another terminal can function as an FTP client, and all types of data can be shared between the terminals. In response to an issuance of the notification of the completion of the WiFi-Direct connection to the data transmission/reception unit 142, the reception terminal operates an FTP server to receive an FTP connection request from the transmission terminal. The data transmission/reception unit 142 in the transmission terminal functions as an FTP client and issues the FTP connection request to the reception terminal having a target IP address. The reception terminal accepts the FTP connection request, and issues a notification of the completion of FTP connection to the data transmission/reception unit 142 of the transmission terminal as an FTP client. The data transmission/reception unit 142 in the transmission terminal transmits the data designated by the user to the reception terminal.

The device searching unit 141 requests the control unit 160 to activate a wireless access device and to search for a device available for a wireless direct access, and requests the control unit 160 to attempt to connect to the device found by the control unit 160. Further, the device searching unit 141 manages the overall connection procedure until the wireless direct access connection is completed. The device searching unit 141 establishes the wireless direct access channel to the target terminal in association with the control unit 160 to complete the connection with the target terminal using the PIN code transmitted from the input unit 120. According to aspects, only the terminals sharing the PIN code information associated with the agreed motion with the transmission terminal may be connected to each other, and the device searching unit 141 may be associated with the control unit 160 to complete the connection with the target terminal based on PIN code authentication. An example of the PIN code authentication will be described below.

First, the flow control unit 140 receives from the input unit 120 the data transfer request including the PIN code, for example, an 8-digit decimal number, and a data location path. In the case of implementing the information in C code, the information may be represented by struct as shown below.

struct
{
char * pin_code;
char *file_path;
}

The PIN code information is transmitted to the device searching unit 141 and the data location path is transmitted to the data transmission/reception unit 142.

The terminal equipped with the Android platform may issue a data transfer request by calling a function offered by a service through a binder and transmitting a message to a thread that manages the flow control unit 140. The data transfer request may be transmitted to the flow control unit 140 by placing a connection request message including the information received from the input unit 120 into a message queue of the thread.

After receiving the data transfer request from the input unit 120, the device searching unit 141 requests the control unit 160 to search for a wireless direct access device to which the data is to be transmitted. The control unit 160 searches for peripheral devices and transmits the search result to the device searching unit 141. The device searching unit 141 requests the control unit 160 to attempt a wireless direct access to the first device in the search result list. The control unit 160 uses the PIN code information received from the device searching unit 141 to search for a reception terminal corresponding to the PIN code information, and after completing the search, transmits information about the reception terminal to the flow control unit 140. The device searching unit 141 requests the control unit 160 to issue a connection request to the found target reception terminal, and the control unit 160 starts wireless direction access to the target reception terminal. In response to a notification receipt from the control unit 160 that the wireless direct access connection is completed, the device searching unit 141 notifies the data transmission/reception unit 142 about the completion of the wireless direct access connection, so that the data transmission/reception unit 142 can initiate the data transfer. If the device searching unit 141 fails to discover a target reception terminal within a certain period of time, or if the device searching unit 141 fails to complete connection between the transmission terminal and a reception terminal in which a pre-agreed user input motion is performed, the data transfer process is cancelled and the cancellation is informed to the user through a pop-up window, or the like.

The data transmission/reception unit 142 is included in the flow control unit 140 and performs a data transfer process. To perform the data transfer process, the data transmission/reception unit 142 sets a connection for a data transmission and transmits or receives target data to or from a target terminal according to the data path received from the input unit 120. In response to the notification of the completion of wireless direct access connection from the control unit 160, the device search unit 141 informs the data transmission/reception unit 142 of the completion of the wireless direct access connection. The data transmission/reception unit 142 establishes the connection for the data transfer, and transmits the target data according to the data path transmitted from the input unit 120 through the established connection. The FTP may be used for the connection for the data transfer.

An FTP connection is based on TCP connection, and thus TCP connection is completed before the FTP connection setting process. A port number of the reception terminal (for example, FTP server) that receives data via the FTP connection may be 21 that may be predetermined and shared by both transmission and reception terminals. In the FTP connection, a value that is the same as the PIN code or a pre-agreed fixed value may be used as user identification (ID) and/or a password. After the completion of the FTP connection setting, the data transfer process is initiated and performed, and information about the data to be transmitted may be identified by a value that is received together with the data transfer request from the input unit 120. Once the FTP connection for a data transfer is completed, the transmission terminal (for example, an FTP client) may arrange settings for TCP connection by setting a destination port as port 20 of an FTP server and perform data transmission. The reception terminal may store file or data in a memory. Hereinafter, detailed operations of the data transfer after the completion of the FTP connection setting will be described.

For a data transfer, a new TCP connection is made without using an existing TCP connection for FTP connection that is previously established. The transmission terminal to transmit data informs the reception terminal of information about a port for new TCP connection for a data transmission, and informs the reception terminal of the data transfer. The reception terminal attempts to establish a TCP connection to the port indicated by the transmitted information, and the transmission terminal accepts the connection attempt and completes the TCP connection establishment. A TCP connection port of the reception terminal may be port 20 that is predetermined between the transmission terminal and the reception terminal. After the TCP connection setting is completed, data transfer is performed between the transmission and reception terminals. A FIN flag of a TCP segment including the last data may be set as “1” to indicate the last data. In response to the receipt of the last data, the reception terminal may perform TCP connection termination process. After the TCP connection is terminated, the reception terminal may inform the transmission terminal of the completion of the data transfer, and the data transfer process is terminated.

The control unit 160 activates a wireless direct access device in response to a request from the flow control unit 140, performs the wireless direct access connection process in association with the signal processing unit 180, and transmits the data received from the data transmission/reception unit of the flow control unit 140 to the signal processing unit 180 so that the data can be transmitted to the peer terminal.

The control unit 160 informs the flow control unit 140 that the wireless direct access connection is completed. In the process of WiFi-Direct connection, the control unit 160 is in charge of IP allocation to both transmission and reception terminals using DHCP, and information about the IP allocated to the terminals is shared with the flow control unit 140 such that the allocated IP may be used for connection settings for a data transfer and the subsequent data transfer.

The control unit 160 may operate as a driver of the wireless direct access device by associating with the signal processing unit 180.

In response to a request from the flow control unit 140 to activate the wireless direct access device, the control unit 160 activates the wireless direct access device to prepare the establishment of a wireless direct access channel. For example, the control unit 160 searches for terminals within a certain range of area in response to a search request, and informs the flow control unit 140 of the search result. In response to an instruction about a connection request transmitted from the flow control unit 140, the control unit 160 controls the signal processing unit 180 to send a connection request message to a target terminal.

After receiving a response from the target terminal, the control unit 160 determines whether PIN code (for example, the second PIN code) included in the response is identical to or matched with the PIN code generated by the input unit 120. If the PIN codes are identical or matched, the control unit 160 sends a connection accept message to the target terminal (the reception terminal) to complete the connection.

In the WiFi-Direct embodiment, after the connection accept message is sent, an IP allocation process through DHCP is performed. For example, one of the connected two terminals serves as a DHCP server, and the other terminal serves as a DHCP client, and then IP allocation process through DHCP can be performed. The server terminal autonomously allocates an IP address to itself. The allocated IP address is shared between the connected two terminals, and used in a data transfer process.

A process for discovering a peer terminal in WiFi-Direct as a wireless direct access scheme will be described in detail below.

WiFi-Direct conforms to IEEE 802.11n standard specifications. Terminals to be connected to each other scan all channels conforming to 802.11n standard specifications, and thereafter repeatedly search for particular social channels, that is, channel 1, channel 6, and channel 11, which are specified by the WiFi-Direct standard specifications for fast channel search. The terminals repeatedly perform channel scanning for a predefined time period after a predefined period of waiting time. WiFi alliance applies special requirements to general WiFi for efficient use of wireless network resources in WiFi-Direct. One of the special requirements is prohibition of use of channels supporting data rates of 1, 2, 5.5 and 11 Mbits/sec that are used in 802.11b, and another requirement is prohibition of use of social channels, that is, channels 1, 6 and 11, in 2.4 GHz band as 801.11 standard frequency band. The repeated channel scanning of the specific social channels 1, 6, and 11 is carried out to provide a more efficient usage environment to the terminals that employ WiFi-Direct.

During a terminal searching stage, a WiFi-Direct terminal repeats browsing and waiting operations for a random period of time. A peer-to-peer (P2P) terminal reaching at a searching stage transmits a “probe request frame” to a specific social channel, and if, on the same social channel, there is a P2P terminal staying at a waiting stage, the P2P terminals exchange probe responses to each other as responses to the transmitted probe request so that the two P2P terminals can recognize each other's presence and perform a preparation process for communication between the P2P terminals. If the terminal in the searching stage transmits a probe request to the specific social channel and there is no terminal in a waiting stage on the same channel, the terminal cannot receive a probe response, and repeats entering a waiting stage and searching for another social channel. By doing so, the terminal can search for another WiFi-Direct-available terminal to which the terminal can be connected.

During the terminal searching stage in which a data transmission terminal finds a data reception terminal, an additional attribute is defined in P2P information element (IE) of a probe request or a probe response of the data reception terminal and PIN code information is added to the attribute when the probe response is transmitted. The data transmission terminal may recognize the reception terminal through the PIN code information, and establish a wireless direct access connection to the target terminal based on the PIN code information included in the attribute. In a conventional connection method, a connection request is sent to a terminal found through a terminal searching process, and a response message associated with the connection request is received from the found terminal. Then, a PIN code can be confirmed. In other words, in order to find a reception terminal, that is, a terminal having the same PIN code as the PIN code included in the transmission terminal, a connection request should be sent to the found terminal. After a response to the connection request is received, PIN code included in the response is compared with the PIN code included in the transmission terminal and thereafter a connection between the terminals may be made. Aspects of the present invention enables to identify a target terminal during a searching process by initiating the searching process based on a PIN code shared between users of transmission and reception terminals and receiving the probe response including the PIN code. Thus, the transmission terminal can recognize the target terminal having the same PIN code as that of the transmission terminal among the found terminals during the search process. Accordingly, when multiple terminals are found during the search process, the transmission terminal can identify a target terminal that sent a probe response having the PIN code corresponding to the transmission terminal and send a connection request to the target terminal without an error.

Tagged parameters of a probe response include various information element (IE) tags, and PIN code information attribute may be added to a peer-to-peer (P2P) IE. The P2P IE may include one or more attributes. A format of the PIN code information attribute to be added to the P2P IE in the probe response is provided below.

| | Size | | |
|---|---|---|---|
| Field | (octets) | Value | Description |
| Attribute ID | 1 | 255 | PIN Code Info Attribute among |
| | | | P2P IE Attributes |
| Length | 2 | Variable | Length of PIN Code Information |
| PIN Code | Variable | String | PIN Code Information |

For example, if the PIN code information is 12345678, the format of the PIN code information attribute can be as follows.
P2P PIN Code Info. Attribute
Attribute Type: P2P PIN Code Info. (255)
Attribute Length: 8
PIN code Info.: 12345678

Assigning 255 to attribute ID is to use a reserved value among defined values of the attribute ID included in the P2P IE.

After the terminal search, the control unit 160 confirms whether the connected P2P terminal is the target terminal to be connected to according to the instructions of the flow control unit 140. A connection request message is sent to the terminal designated by the flow control unit 140, and in response to a response message associated with the connection request, the control unit 160 compares the first PIN code received along with the terminal search instruction from the flow control unit 140 and the second PIN code included in the response message. If the first PIN code is identical to or matched with the second PIN code, the control unit 160 transmits a connection accept message and starts IP allocation process through DHCP. If the first and second PIN codes are not identical to or matched with each other, the control unit 160 informs the flow control unit 140 of the failure of the connection request.

Then, the control unit 160 decides the terminal as an owner of a WiFi-Direct group. Because the group owner terminal sets various environmental variables for establishing bidirectional communication channel, the group owner terminal transmits a “Negotiation Request” that is an environment setting message to other terminals by including various environment variables in the message, and receives a “Negotiation Response” as a response responding to the “Negotiation Request”. Through these procedures, the control unit 160 completes negotiation about a communication environment between a terminal requesting for connection and a terminal receiving the connection request, and a generation of the P2P group can be completed. Once the P2P group is formed, a communication channel is established and a bidirectional communication is available.

After the P2P group is generated, an IP address is allocated to a terminal receiving the connection request and functions as a DHCP server and a terminal attempting the connection request. Generally, DHCP is a protocol that dynamically manages IP addresses of a network in a DHCP server and allocates an IP dynamically when requested. Because terminals connected via WiFi-Direct do not require permanent IP allocation, a group owner terminal allocates a valid temporary IP address to the connected terminals while the group owner terminal as a DHCP server is connected to client terminals. As the control unit 160 transmits information about the allocated IP to the flow control unit 140, the flow control unit 140 enables an application to perform various types of IP communications based on the allocated IP.

The signal processing unit 180 frames data to be transmitted via a WiFi-Direct wireless network based on the information received from the control unit 160, and unframes WiFi-Direct data received via the wireless network. Specifically, the signal processing unit 180 may generate data frames from data to be transmitted according to a wireless direct access scheme, and recover original data from the data frames. The signal process unit 180 may include one or more antennas to transmit and/or receive processed data frames.

The signal processing unit 180 may be a device to process data on a frame-by-frame basis through a signal processing process such that the data can be processed based on the information from the control unit 160 and transmitted to a terminal connected over a wireless link or a response frame can be received from the terminal receiving a connection request. The terminals forming the same group during WiFi-Direct connection process generate orthogonal frequency division multiplexing (OFDM) transmission symbols according to IEEE 802.11n wireless standard interface specifications, and transmit WiFi-Direct wireless signal to a wireless link through an antenna.

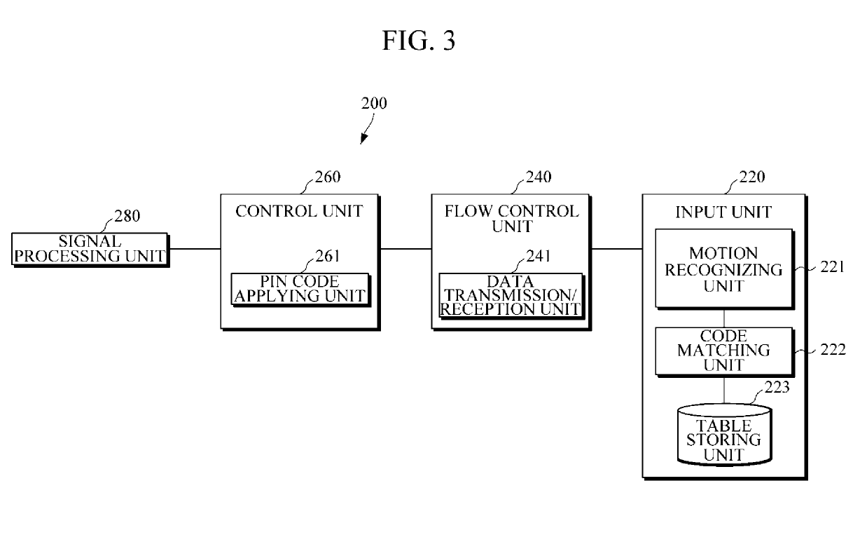

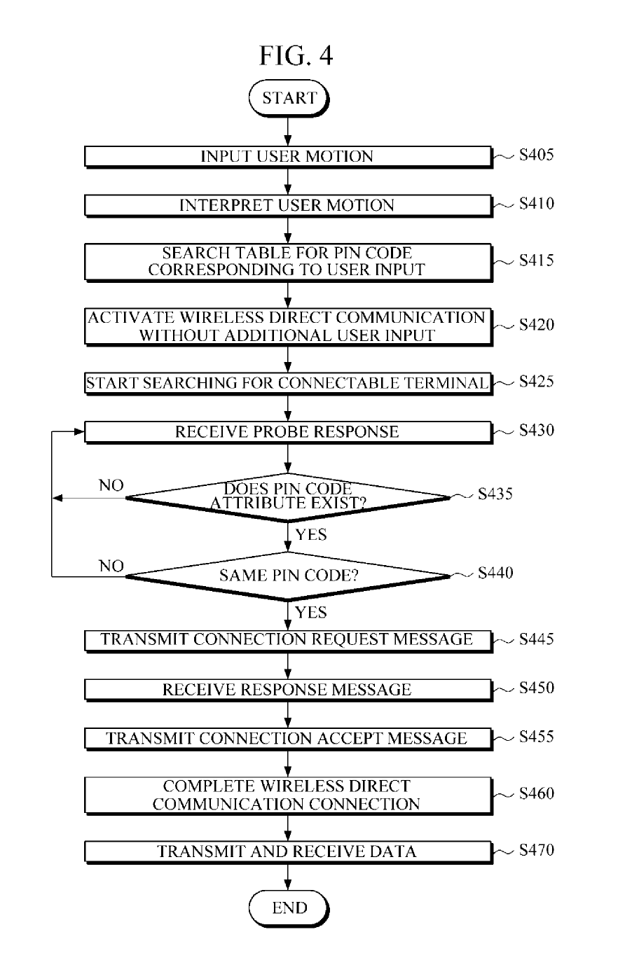

FIG. 3 is a diagram illustrating a wireless communication apparatus according to an exemplary embodiment of the present invention. The wireless communication apparatus shown in FIG. 3 may be an example of a reception terminal (for example, the second terminal in FIG. 1). Further, a terminal may include both transmission terminal features and reception terminal features as illustrated in FIG. 2 and FIG. 3. If a terminal receives a user input to establish a wireless direct access with a selection of data to be transmitted, the terminal may serve as the transmission terminal described with respect to FIG. 2. Further, if the terminal receives a user input to establish a wireless direct access and does not receive a probe request from another terminal, the terminal may serve as the transmission terminal described with respect to FIG. 2. If a terminal receives a user input to establish a wireless direct access and receives a probe request from another terminal, the terminal may serve as a reception terminal described below with respect to FIG. 3. Further, a terminal may determine whether to transmit data as a transmission terminal or to receive data as a reception terminal based on whether a data path is selected by the terminal. If the data path is selected, the terminal may operate as a transmission terminal and may perform the procedure described with respect to FIG. 2 and FIG. 4.

Referring to FIG. 3, the wireless communication apparatus 200 may include an input unit 220, a flow control unit 240, a control unit 260, and a signal processing unit 280. The input unit 220, the flow control unit 240, the control unit 260, and the signal processing unit 280 shown in FIG. 3 may have the same or similar features and operations as the input unit 120, the flow control unit 140, the control unit 160, and the signal processing unit 180 shown in FIG. 2, respectively.

The device search unit 141 included in the flow control unit 140 of FIG. 2 is not illustrated in FIG. 3 since a reception terminal need not operate the device search unit 141; however, a device search unit 141 may be included.

The control unit 160 shown in FIG. 2 includes the PIN code check unit 161 whereas the control unit 260 shown in FIG. 3 includes a PIN code applying unit 261. The PIN code check unit 161 may determine the similarity between PIN code (the first PIN code) generated by the input unit 120 in the transmission terminal and a PIN code (the second PIN code) included in a probe request. The PIN code applying unit 261 may insert a PIN code (the second PIN code) generated by the input unit 220 in the reception terminal into the probe request.

Operations of the flow control unit 240 in the reception terminal may be implemented more simply compared to the flow control unit 140 in the transmission terminal. For example, the input unit 220 transmits PIN code information that is the same as a PIN code generated in the transmission terminal based on a user input corresponding to a user's specific motion, together with a data reception request, to the flow control unit 240. In response to the reception request, the flow control unit 240 requests the control unit 260 to activate a WiFi-Direct device. Then, the flow control unit 240 receives a notification from the control unit 260 that the WiFi-Direct device is activated, and waits until receiving a notification of the completion of WiFi-Direct connection from the control unit 260. In response to the notification of the completion of the WiFi-Direct connection from the control unit 260, a data transmission/reception unit 241 performs a data transfer with the transmission terminal. When receiving data using a FTP connection, the data transmission/reception unit 241 drives an FTP server after completing the WiFi-Direct connection, and waits for an FTP connection request from the transmission terminal. In response to the FTP connection request from the transmission terminal, the data transmission/reception unit 241 in the reception terminal accepts the FTP connection request and informs the transmission terminal as an FTP client that the FTP connection is completed. Thereafter, the data transmission/reception unit (for example, data transmission/reception unit 142) in the transmission terminal sends data designated by the user to the reception terminal.

FIG. 4 is a flowchart illustrating a method for establishing a wireless access channel by a transmission terminal according to an exemplary embodiment of the present invention. FIG. 4 will be described as if performed by the wireless communication apparatus 100 shown in FIG. 2, but is not limited as such.

Referring to FIG. 2 and FIG. 4, a user inputs a data transfer request to the input unit 120 of the wireless communication apparatus (“terminal”) through a specific motion in operation S405. The input unit 120 transmits user input information to the motion recognizing unit 121 and the motion recognizing unit 121 interprets the user motion and converts the user motion into a value mapped to the user motion in operation S410. The code matching unit 122 reads PIN code information corresponding to the user motion from a code table in which the user motions and PIN codes are mapped to each other, and transmits the read PIN code information to the input unit 120 in operation S415. The input unit 120 transmits the user's data transmission request generated according to the user motion along with the PIN code information to the flow control unit 140, and the device search unit 141 of the flow control unit 140 activates a wireless direct communication through the control unit 160 in operation S420. The device search unit 141 requests the control unit 160 to search for a peripheral device available for the wireless direct access connection, and the control unit 160 searches for one or more terminals available for the wireless direct access connection in operation S425. Then, the signal processing unit 180 receives a probe response from a terminal available for a wireless direct access in operation S430. The control unit 160 determines whether a PIN code attribute is included in an information element (IE) of the received probe response, and if there is no PIN code attribute in the probe response, the signal processing unit 180 waits for another probe response in operation S435. If there is a PIN code attribute in the IE of the received probe response, the signal processing unit 180 extracts PIN code information of the terminal that transmits the probe response from the PIN code attribute and checks whether the extracted PIN code information is identical to or matched with the read PIN code information in operation S415. If the two pieces of PIN code information are not identical to or matched with each other, the signal processing unit 180 waits for another probe response in operation S440. If two pieces of PIN code information are identical to or matched with each other, the signal processing unit 180 sends a connection request message to the corresponding terminal in operation S445. Then, the signal processing unit 180 receives a connection response message and transmits a connection accept message to complete the wireless direct communication connection in operations S450 and S455. After completing the wireless direct communication connection in operation S460, the data transmission/reception unit 142 transmits data to the connected terminal over the established wireless direct access channel in operation S470.

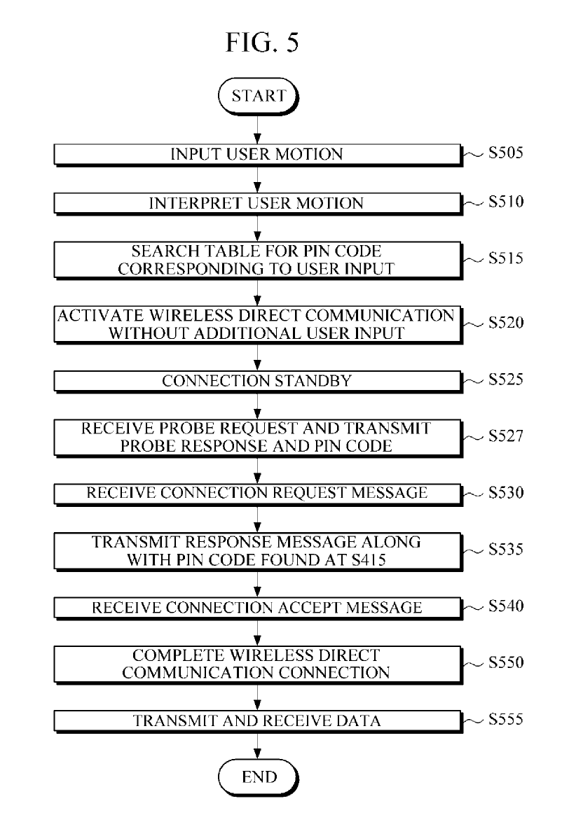

FIG. 5 is a flowchart illustrating a method for establishing a wireless access channel by a reception terminal according to an exemplary embodiment of the present invention. FIG. 5 will be described as if performed by the wireless communication apparatus 200 shown in FIG. 3, but is not limited as such.

Referring to FIG. 3 and FIG. 5, a user informs the terminal of a reception request by inputting a motion corresponding to the user's motion input to the transmission terminal in the operation S405 of FIG. 4, and the input unit 220 recognizes the input user motion in operation S505. The input unit 220 transmits user input information to the motion recognizing unit 221 and the motion recognizing unit 221 interprets the user motion and converts the user motion into a value corresponding to the user motion in operation S510. The motion recognizing unit 221 reads PIN code information corresponding to the user motion from a code table in which the user motions and PIN codes are mapped to each other and transmits the PIN code information to the input unit 220 in operation S515. The input unit 220 transmits user's data reception request along with the PIN code information to the flow control unit 240, and the flow control unit 240 activates a wireless direct communication through the control unit 260 in operation S520. The flow control unit 240 monitors a probe request for terminal search in operation S525. In response to receipt of the probe request, the control unit 260 transmits the probe response by inserting the PIN code received in the operation S520 into the probe response in operation S527. In response to receipt of a connection request message through the signal processing unit 280, the control unit 260 transmits the connection response message and receives the connection accept message, and then the wireless direct access connection is completed in operations S530, S535, S540, and S550, respectively. The data transmission/reception unit 241 receives the data from the transmission terminal through the wireless direct access connection in operation S555.

According to aspects of the present invention, after one-to-one data transfer is completed, data may be re-transmitted to another terminal that transmits a probe response including the same PIN code, and data sharing between more users may be realized. In addition, through one-to-multiple connection, one specific input received on terminals to be connected via wireless direct access may enable multiple terminals to establish wireless channels and to share data among the multiple terminals.

Further, a specific motion input by a user can be associated with a particular file or data (for example, a contact, a name card, etc.), a user can manipulate a terminal to select desired data through the associated specific motion, and the terminal receiving the specific motion can transmit the requested file or data by the motion corresponding to the data.

Further, if a user's specific motion is input to a transmission terminal, the transmission terminal transmits pre-arranged data to a reception terminal and the reception terminal may run an application that is previously mapped to the received data value. For example, when a word is input or selected in the transmission terminal, a dictionary application in the reception terminal is executed using a wireless access connection so as to display a definition of the word input or selected in the transmission terminal.

As illustrated in the above examples, since PIN code is transmitted during terminal search, it is possible to simplify a complicated process for establishing a channel between terminals available for wireless direct access. In addition, if the PIN code is generated according to a user's specific motion, the user does not need to manually input the PIN code.

The methods and/or operations described above may be recorded or stored in one or more computer-readable storage media that includes program instructions configured to be executed by a processor. The media may also include, alone or in combination with the program instructions, data files, data structures, and the like. Examples of computer-readable storage media include magnetic media, such as hard disks, floppy disks, and magnetic tape; optical media, such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A terminal to establish a wireless access channel, comprising:
an input unit to receive a user input to establish a wireless access channel for a data transfer, the user input corresponding to first identification information;
a flow control unit to search for a target terminal in response to the user input, and to establish a wireless access channel with the target terminal if a response comprising second identification information corresponding to the first identification information is received from the target terminal; and
a control unit to check whether the second identification information corresponds to the first identification information.

2. The terminal of claim 1, wherein the wireless access channel is established based on WiFi Direct.

3. The terminal of claim 1, wherein the second identification information is included in an attribute of a peer-to-peer information element of the probe response.

4. The terminal of claim 1, wherein the flow control unit transmits a probe request to search for a terminal available for a wireless access connection.

5. The terminal of claim 4, wherein the flow control unit receives the response comprising the second identification information as a probe response in response to the transmission of the probe request.

6. The terminal of claim 1, wherein the first identification information comprises a personal identification number (PIN) code that matches the user input.

7. The terminal of claim 1, wherein the user input comprises at least one of a motion sensed by a camera, a key pad input, an input sensed by an embedded sensor, and a touch input.

8. The terminal of claim 1, wherein the input unit comprises:
an input recognizing unit to recognize the user input; and
a table storing unit to store a code table including mapping information between the user input and a personal identification number (PIN) code.

9. The terminal of claim 1, wherein the flow control unit transmits data via the established wireless access channel.

10. A terminal to establish a wireless access channel, comprising:
an input unit to receive a user input corresponding to first identification information;
a signal processing unit to receive a probe request for establishing a wireless access channel from a transmission terminal, and to transmit a probe response in response to the probe request;
a control unit to generate the probe response comprising the first identification information; and
a flow control unit to establish a wireless access channel with the transmission terminal if a connection request message is received in response to the probe response, and to receive data via the established wireless access channel.

11. The terminal of claim 10, wherein the first identification information is included in an attribute of a peer-to-peer information element of the probe response.

12. The terminal of claim 10, wherein the first identification information comprises a personal identification number (PIN) code that matches the user input.

13. The terminal of claim 10, wherein the connection request message indicates an authentication success for the first identification information.

14. A method for establishing a wireless access channel, comprising:
receiving a user input to establish a wireless access channel for data transfer, the user input corresponding to first identification information;
searching for a target terminal in response to the user input;
receiving a probe response comprising second identification information from the target terminal;
determining whether the second identification information corresponds to the first identification information; and
establishing a wireless access channel with the target terminal if the second identification information corresponds to the first identification information.

15. The method of claim 14, wherein the wireless access channel is established based on WiFi Direct.

16. The method of claim 14, wherein the second identification information is included in an attribute of a peer-to-peer information element of the probe response.

17. The method of claim 14, further comprising: transmitting a probe request to search for a terminal available for a wireless access connection.

18. The method of claim 14, wherein the first identification information comprises a personal identification number (PIN) code that matches the user input.

19. A method for establishing a wireless access channel, comprising:
receiving a user input corresponding to first identification information;
receiving a probe request for establishing a wireless access channel from a transmission terminal;
transmitting a probe response comprising the first identification information in response to the probe request;
establishing a wireless access channel with the transmission terminal if a connection request message is received in response to the probe response; and
receiving data via the established wireless access channel.

20. The method of claim 19, wherein the first identification information is included in an attribute of a peer-to-peer information element of the probe response.

21. The method of claim 19, wherein the first identification information comprises a personal identification number (PIN) code that matches the user input.

22. The method of claim 19, wherein the connection request message indicates an authentication success for the first identification information.
